(19) United States
(12) Patent Application Publication
(10) Pub. No.: US 2015/0200725 A1
(43) Pub. Date: Jul. 16, 2015

(54) Lighting System Communication

(71) Applicant: Infineon Technologies Austria AG, Villach (AT)

(72) Inventor: Tobias Heuken, Muenchen (DE)

(73) Assignee: Infineon Technologies Austria AG, Villach (AT)

(21) Appl. No.: 14/153,117

(22) Filed: Jan. 13, 2014

(51) Int. Cl. H04B 10/116

(52) U.S. Cl. CPC H04B 10/116

(57) ABSTRACT

A lighting system including a plurality of light modules is provided. Each of the light modules may be configured to emit visible light. At least one light module may be configured to communicate with another light module by modulating the emitted visible light with information that is to be communicated. The modulation of the visible light may be unnoticeable to the human eye.

Further, a method for controlling a plurality of light modules is provided. The method may include: emitting visible light by a first light module of the plurality of light modules; modulating the emitted visible light with data that is to be transferred to at least one other light module of the plurality of light modules, wherein the modulation of the visible light is not noticeable to the human eye; receiving the modulated visible light by the at least one other light module; demodulating the received visible light by the at least one other light module to recover the data; and responding of the at least one other light module to the recovered data.

### TECHNICAL FIELD

Various embodiments generally relate to communication techniques for lighting systems.

### BACKGROUND

Lighting systems may include light modules. The light modules may be controlled, for example, by providing a network connection for each light module. The network connections may be wired or wireless. However, installing a wired network connection for each light module may be costly. Further, wireless network connections such as Bluetooth, WLAN, ZIGBEE may consume electrical power and may expose a person to high frequency electromagnetic radiation and increase the system cost due to additional parts required for communication.

### SUMMARY

A lighting system including a plurality of light modules is provided. Each of the light modules may be configured to emit visible light. At least one light module may be configured to communicate with another light module by modulating the visible light emitted by the at least one light module with information that is to be communicated. The modulation of the visible light may be unnoticeable to the human eye.

Further, a method for controlling a plurality of light modules, for example for illuminating a room, is provided. The method may include: emitting visible light by a first light module of the plurality of light modules; modulating the emitted visible light with data that is to be transferred to at least one other light module of the plurality of light modules, wherein the modulation of the visible light is not noticeable to the human eye; receiving the modulated visible light by the at least one other light module; demodulating the received visible light by the at least one other light module to recover the data; and responding of the at least one other light module to the recovered data.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the drawings, the left-most digit(s) of a reference number may identify the drawing in which the reference number first appears. The same numbers may be used throughout the drawings to reference like features and components.

In the following description, various embodiments of the invention are described with reference to the following drawings, in which:

FIG. 1 shows one embodiment of a lighting system according to one or more aspects of this disclosure;

FIG. 2 shows another embodiment of a lighting system according to one or more aspects of this disclosure;

FIG. 3 shows another embodiment of a lighting system according to one or more aspects of this disclosure;

FIG. 4 shows another embodiment of a lighting system according to one or more aspects of this disclosure; and

FIG. 5 shows a method for controlling a lighting system according to one or more aspects of this disclosure.

### DETAILED DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

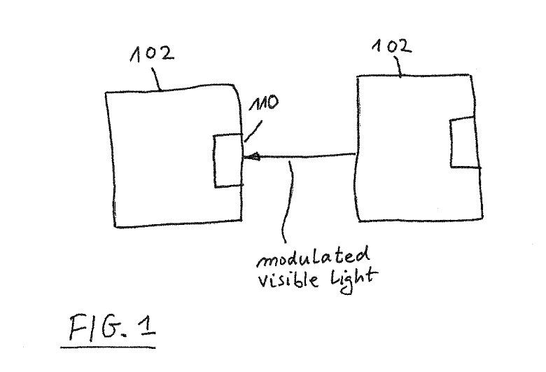

FIG. 1 shows an embodiment 100 of a lighting system. The lighting system may include two light modules 102, for example configured for illuminating a room. For example, the light modules 102 may be fixed on a ceiling or on a wall. Each of the light modules 102 may be configured to emit visible light. One of the light modules 102 may be illuminate a first area and the other may illuminate a second area. The first area and the second area may overlap or be separate from each other. The light modules 102 may be light-emitting diodes. One of the light modules 102 may be called device and the other may be called a second device.

The two light modules 102 may be arranged to be in line of sight with each other. At least one of the two light modules 102 may be configured to modulate the visible light emitted by the at least one light module 102 with information that is to be communicated in order to communicate with the other light module 102. The modulation itself may chosen so that it is not detectable by a human eye.

The other light module 102 may have a light sensor 110. The light sensor 110 may be configured to receive the modulated emitted visible light. The other light module 102 may demodulate the received modulated emitted visible light to recover the information. It may respond to the information.

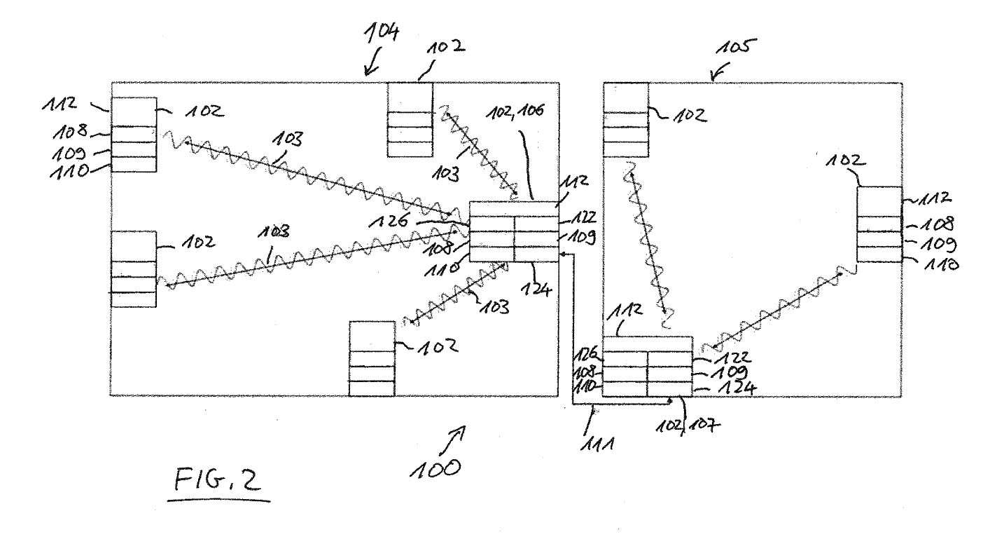

FIG. 2 shows an embodiment 100 of a lighting system. The lighting system may include a plurality of light modules 102. A light module 102 may include a light-emitting unit or light emitting element 112, a control unit 108, a supply input 109 and a light sensor 110. For the sake of clarity, these features are not labeled in all light modules 102.

Each of the light modules 102 may be configured to emit visible light, for example via the light-emitting unit 112. Visible light may be electromagnetic radiation that can be sensed by the human eye, for example electromagnetic radiation with wavelengths between the infrared and the ultraviolet. The control unit 108 may be configured to control the light-emitting unit 112, for example by adjusting the intensity or the color temperature of the emitted visible light. The color temperature of a light source is the temperature of an ideal black body radiator that radiates light of comparable hue to that of the light source and is stated in Kelvin. Color temperatures over 5,000K are called cool colors (bluish white) and may be used to enhance concentration in offices. Lower color temperatures between 2,700-3,000 K are called warm colors (yellowish white through red) and may be used to promote relaxation. The supply input 109 may be connected to an AC supply, for example a mains connection. The supply input 109 may be used to power the light module 102 and the components inside, for example the control unit 108, the light-emitting unit 112 and the light sensor 110.

At least one light module 102 may be configured to communicate with another light module 102 by modulating the visible light emitted by the at least one light module 102 with information that is to be communicated. The light modules 102 may communicate with each other using optical communication in the visible range. As the communication channel is free space (or air), the communication may be wireless without the need for installation. The visible light already present, for example for illuminating a room, may be used for communication and little or no additional energy may be used beyond that needed to power the at least one light module to emit light for purposes of illuminating an area.

Each light module 102 may include a modulation module, such as a transmitter, a receiver or a transmitter and a receiver. The communication between the light modules 102 may be unidirectional or bidirectional. It may be half-duplex or full-duplex. In half-duplex communication, the light modules 102 may communicate with one another in both directions, but only in one direction at a time. In a full-duplex communication, the light modules 102 may communicate with one another in both directions simultaneously. The transmitter may encode (or modulate) information (or data), for example via the control unit 108, onto the visible light emitted for purposes of illumination. The receiver may include the light sensor 110 for receiving the modulated visible light. The light sensor 110 may be sensitive to white light. It may for example be a photodiode, a phototransistor or any component capable of measuring one or more properties of light, such as intensity, polarization, color temperature, etc. The light sensor 110 may include separate sensors for different colors, for example for red, green and blue, for example to optimize the detection of a specific color. The receiver may include demodulation logic that may be configured to decode (or demodulate) the received modulated visible light to reproduce the information. In various embodiments, the receiver and transmitter may be integrated into the ballast of an LED.

The plurality of light modules 102 may have point-to-point optical links 103 between the light modules 102. The optical links 103 may be along line-of-sights of the light modules 102. In other words, a light module 102 may be “seen” from another light module 102. In other examples, the optical links 103 may involve scattered or reflected visible light. If the light module 102 has a transmitter, it may send instructions along the optical links 103 to other light modules 102, for example to control them. If the light module 102 has a receiver, it may receive instructions or information along the optical links 103.

Light modules 102 may be configured to modulate emitted visible light such that the modulation itself is not detectable to a human eye. In other words, light modules 102 may be configured to modulate emitted visible light such that a human being may not be able to tell the difference between modulated and unmodulated visible light. In still other words, light modules 102 may be configured to modulate emitted visible light such that the modulation will not noticeably affect the illumination function of a lighting system including light modules 102. In some examples, light modules may use amplitude modulation to modulate information onto emitted light, that is, an intensity of the emitted visible light may be modulated. For example, the current intensity may be reduced by 10 to 50% or by 100%. The light modules 102 may modulate the emitted light at a frequency, for example above 1 kHz, that cannot be perceived by the human eye. However, the frequency is not limited to 1 kHz. It may be any frequency that a human eye is incapable of perceiving or detecting, for example, it may be higher than 60 Hz.

In various embodiments, the emitted visible light may include at least one of a red component, a green component, and a blue component. At least one of the red component, the green component, and the blue component may be modulated with information that is to be communicated between the light modules 102. In various embodiments, not all of the components are modulated. The component that is modulated may be a component that has a color which is not present in the environment of the lighting system. For example, a green or a blue component may be modulated in the presence of a red structure, such as a wall. A full-duplex communication may be achieved by modulating different components for different directions which may be received by light sensors sensitive to only one component.

Visible white light may be generated by mixing the primary colors red, green and blue (RGB), which may, for example, be generated by individual light-emitting diodes. In various embodiments, visible white light may be generated by a phosphor material converting monochromatic light from a blue or ultraviolet LED. The visible white light may be modulated with information that is to be communicated.

In various embodiments, the information that is to be communicated may be an instruction for the light module 102 which receives the modulated visible light. In various embodiments, the information may be a report to another light module 102 about the state of the light module 102 which emits the modulated visible light, or one or more measurements made by the respective light module 102. For example, a light module 102 may measure an intensity of ambient light in the vicinity of light module 102, a color of light in the vicinity of light module 102, or any other property and communicate an indication of the measurement via modulated visible light as described herein.

In various embodiments, the information may include at least one of the following: an identifier (or address) of a light module 102, an operating parameter of the light module 102, a temperature of a light module 102, an up-time or running time of a light module 102, a power consumption of a light module 102, a color temperature of the emitted light of a light module 102, a color temperature of light ambient to a light module 102, a brightness of light ambient to a light module 102, and a light setting of a light module 102. For example, an identifier may include a binary or other value that indicates an identity of a respective light module 102. As one specific example, a third light module 102 of a lighting system may have the identifier “3”, which may be represented by the binary number “010”. According to this example, the light module 102 may identify itself to another light module 102 by modulating a “0” followed by a “1” followed by a “0” onto emitted light. After identification, other values, such as operating parameters, temperatures, etc. may be similarly coded and transmitted. A light setting may be characterized by a predetermined arrangement of operating parameters, for example light intensity, light color temperature, etc., and may be linked to a suitability of the light. Examples of a light setting may be light considered suitable for leisure, for work, or for standby. For example, light considered suitable for leisure may have a lower intensity (or brightness) and a higher portion of red component while light considered suitable for work may have a higher intensity and a higher portion of blue component.

In various embodiments, the information does not change quickly over time and may be communicated with a low data rate, for example between 1 to 10 kB/s. The low data rate may reduce a complexity of components needed for communication, such as the receiver and the transmitter. The data rate should be high enough that the modulation is not perceivable by a human eye. In some examples, components for communication with a high data rate may be used.

In various embodiments, the light sensor 110 may be configured to measure a color temperature of light, for example of ambient light or the light emitted by a light module 102. In various embodiments, the color temperature may be transmitted to a master light module 106 (described below) which may transmit instructions to change the color temperature of at least one light module 102 to achieve a desired color temperature at the location of the light sensor 110. In this way, color effects of the surroundings of the light module 102 may be taken into account.

In various embodiments, the light module 102 includes at least one light-emitting diode, for example in the light-emitting unit 112. The at least one light-emitting diode may be a semiconductor light-emitting diode (LED), an organic light-emitting diode (OLED), or a polymer light-emitting diode (PLED). Light-emitting diodes may have very short turn-on and turn-off times and may be modulated at a frequency high enough to be unnoticeable to the human eye. However, any kind of light-emitting unit 112 may be used, as long as turn-on and turn-off times are short enough to allow a modulation of the emitted visible light that is not perceivable by the human eye.

In various embodiments, the light modules 102 may be arranged in a room 104. The visible light emitted by the light modules 102 may be used for illuminating the room 104, for example with white light. However, the lighting system may be used in any situation in which the optical communication using modulated visible light possible. Arranging the light modules 102 in a room or a similar structure may reduce the amount of light, for example from the sun, which may interfere with the communication between the light modules 102.

In various embodiments, one of the light modules 102 may be configured as a master 106. The master 106 may have all the elements of a light module 102, that is, a light-emitting unit 112, a control unit 108, a supply input 109 and a light sensor 110. However, the master 106 may additionally have a switch, a network interface 124 and a variable input 126, for example a potentiometer.

Master 106 may be configured to control other light modules 102, for example by transmitting operating instructions to the light modules 102 and receiving information from them. The wireless communication using modulation of the visible light emitted by the light modules 102 and the master 106 for illuminating a room allows a decentralized, intelligent and flexible lighting system without installation.

The switch 122 may be used to turn some or all of the light modules 102 of the lighting system via the master 106 on or off. The variable input 126 may be used to set the brightness or the color temperature or both of the lighting system or the light modules 102. The switch 122 and the variable input 126 may be combined in a user interface.

In various embodiments, the master 106 may be connected to a network 111, for example via the network interface 124. The network 111 may for example be a local area network (LAN), a wireless local area network (WLAN), a Bluetooth network, a cellular network (3G, 4G), or a general home automation network, such as KNX, which is a home automation standard. In various embodiments, the master 106 may be connected to the network 111 via the supply input 109. For example, the AC supply or mains may be used for power-line communication (PLC) which is also known as power-line carrier, power-line digital subscriber line (PDSL), mains communication, power-line telecommunications, or power-line networking (PLN). The master 106 may be controlled via network 111. The master 106 may transfer information, for example operating parameters of the light modules 102, via network 111.

In various embodiments, master 106 may be connected to another master 107. A master in this context may be limited to a respective area, for example, to a room. A master may control light modules 102 in the respective area which are not controllable by other masters. The another master 107 may be configured like master 106, that is, it may have a light-emitting unit 112, a control unit 108, a supply input 109 and a light sensor 110, a switch 122, a network interface 124 and a variable input 126. The another master 107 may also be configured to control light modules 102, for example in room 105. Master 106 may be connected to the another master 107 via the network 111 or via modulated visible light.

While only two masters 106, 107 are shown in FIG. 2, the lighting system may have any number of masters, which may be connected by one or more networks.

In various embodiments, the master 106 and the another master 107 may be located in different rooms. For example, master 106 may be located in room 104 and the another master 107 may be located in room 105. The master 106 and the another master 107 may communicate with each other and may share information. For example, the information that the switch 122 of master 106 in room 104 has been activated to turn on light by activating light modules 102 may be transferred to the another master 107 which may also turn on light by activating light modules 102 in room 105.

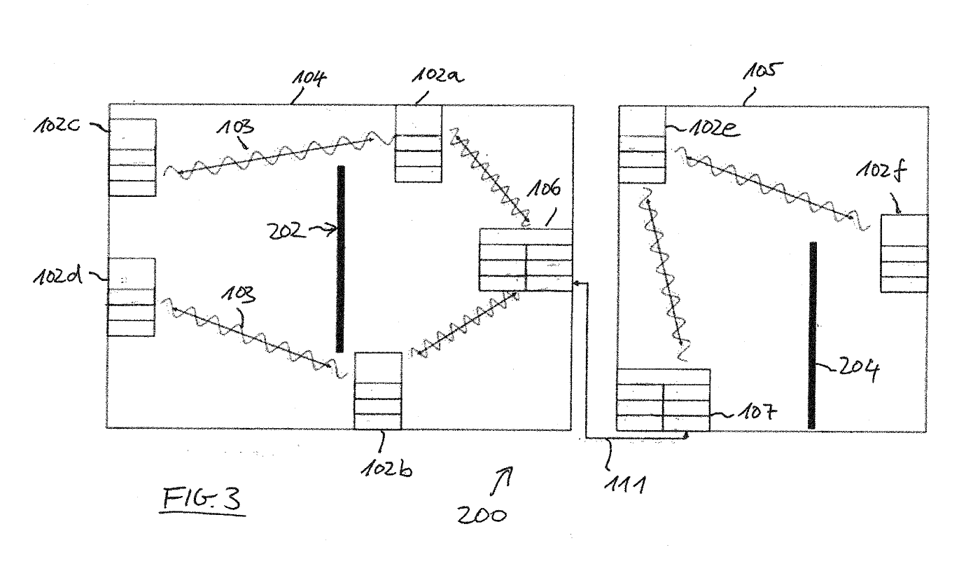

FIG. 3 shows an embodiment 200 of a lighting system. Embodiment 200 may be similar to embodiment 100 described in conjunction with FIG. 1, so that the description of embodiments 100 may also apply to embodiment 200. The lighting system may again extend over the two rooms 104 and 105. In some examples, such as depicted in FIG. 2 with respect to room 104, the light modules 102a and 102b may be arranged with direct line-of-sight to the master 106. However, there may be differences with respect to FIG. 1.

The light modules 102c and 102d may be arranged without direct line-of-sight to the master 106. For example, an obstacle 202 between the light module 102c and the master 106 and between the light module 102d and the master 106 may prevent a direct line-of-sight. The obstacle 202 may for example be a wall, a piece of furniture or any other kind of obstruction that hinders the desired communication via modulated visible light in room 104. For example, the obstacle 202 may be an interfering light source which prevents communication via modulated visible light.

In various embodiments, light modules 102 without a direct line-of-sight to the master 106 may be arranged with an indirect line-of-sight to the master 106, for example via at least one other light module 102 that is arranged in line-of-sight to the master 106. For example, light module 102c does not have a direct line-of-sight to the master 106. However, it may have an indirect line-of-sight to the master 104, for example via light module 102a, as light module 102c may be arranged in line-of-sight to light module 102a and light module 102a may be arranged in line-of-sight of master 106. Consequently, light module 102c and master 106 may communicate with each other. Similarly, light module 102d does not have a direct line-of-sight to the master 106 but may communicate with the master 106 via light module 102b, which has direct line-of-sight with both the light module 102d and the master 106.

The light module 102, for example 102c, which does not have a direct line-of-sight to the master 106, may communicate its address (or identifier) to another light module 102, for example 102a, to which it has a line-of-sight. The another light module 102, for example 102a, may have line-of-sight to the master 106 and may communicate the address to the master 106. The master 106 may then use the address to communicate with a light module 102 which does not have a direct line sight to the master 106. The another light module 102, for example 102a, may be configured to pass any information between the light module 102 which does not have a direct line-of-sight, for example 102c, and the master 106.

While only one light module 102 (here 102a and 102b) is shown in FIG. 2 between the light module 102 (here 102c and 102d) that does not have a direct line-of-sight to the master 106 and the master 106, any number of light modules 102 may be present in between. For example, if there is an obstacle between the light module 102a and the master 106, instead of communicating directly with the master 106, light module 102a may communicate with light module 102b, which may then communicate with the master 106.

In room 105, light module 102e may be arranged with direct line-of-sight to the another master 107, and light module 102e may communicate directly with the another master 107. However, light module 102f may be without a direct line-of-sight with the another master 107 due to another obstacle 204 between the light module 102f and the another master 107. The another obstacle 204 may again be a wall, a piece of furniture or anything that prevents communication between a light module 102 and the another master 107 via modulated visible light in room 105. However, light module 102f may communicate with the another master 107 via light module 102e, in a similar way as described above.

While only one obstacle 202, 204 is shown in each room 104, 105, there may be a more than one obstacle in a room. The same principle may be used to circumvent the obstacles. The light modules 102 may circumvent the obstacles by communicating along a serial optical path made up of light modules 102 that have line-of-sight with neighboring light modules 102 of the serial optical path. A first one or a last one of the light modules 102 of the serial optical path may have a line-of-sight with the master 106.

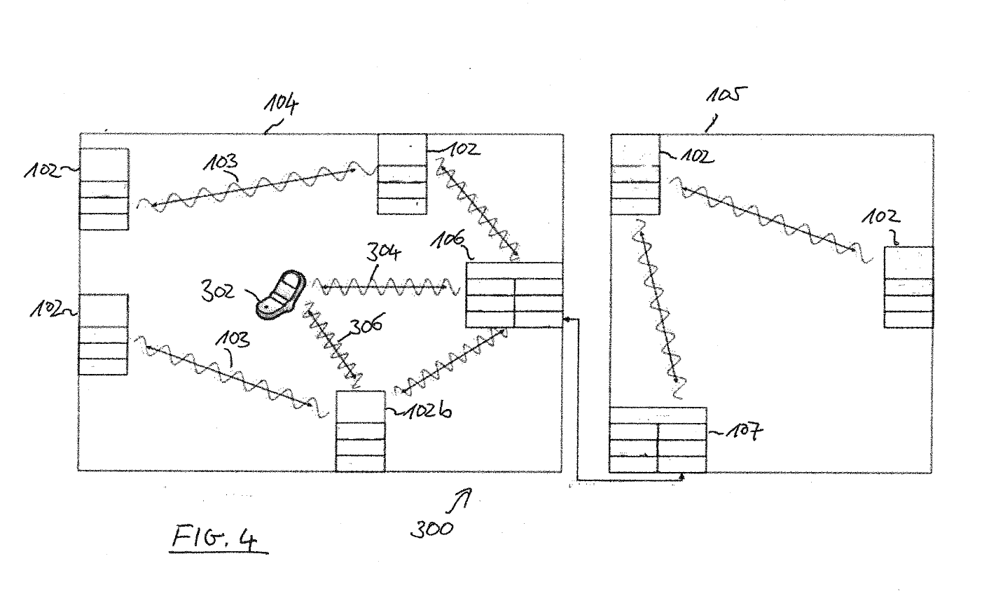

FIG. 4 shows an embodiment 300 of a lighting system. Embodiment 300 may be similar to embodiment 200 described in conjunction with FIG. 2, so that the description of embodiment 200 may also apply to embodiment 300. The optical links 103 may be the same. However, they may be differences. In contrast to embodiment 200, there are no obstacles 202, 204 shown in the rooms 104, 105, respectively.

In various embodiments, at least one of the plurality of light modules 102 may be configured to be controlled by a mobile visible light source 302. The mobile visible light source 302 may be a mobile communication unit, for example a smartphone, a mobile phone, a tablet computer, a personal digital assistant (PDA), an e-reader, a laptop, etc. The mobile visible light source 302 may communicate with the light module 102b over optical link 306. It may, for example, instruct the light modules 102 to emit visible light, for example with a given intensity and color temperature.

The mobile visible light source 302 may communicate with the master 106 over optical link 304. For example, the master 106 may be controlled by the mobile visible light source 302 to turn on all light modules 102 in room 104.

The communication may be as described above, that is by modulating the visible light emitted by the mobile visible light source 302. However, other ways of communication, such as infrared (IR) remote control, Bluetooth, and Wi-Fi, are possible.

In various embodiments, the mobile visible light source 302 may be an electronic flash or camera flash, for example, of a mobile communication unit. The flash may for example be generated by one or more high-current flash LEDs. Because of the high intensity of the flash, the communication may be robust over interfering light, as a threshold for the sensitivity of the light sensors may be increased. Alternatively, the mobile visible light source may be the display the mobile communication unit. The display may for example be turned to its maximal brightness and emit a white color for a short time.

The communication may be based on a duration of the flash. A short duration may lead to a different instruction than a long duration. For example, a flash duration of 100 μs may control at least one light module 102, or control the master 106 to give instructions to the light modules 102, to use a certain light mode, for example suitable for work. A flash duration of 150 μs may control the lighting system to provide light suitable for watching television.

The communication may be based on a sequence of flashes. For example, a sequence of five short flashes may control (or instruct) the lightning system to provide a work light mode, and a sequence of ten long flashes to provide a leisure light mode.

The mobile visible light source 302 may also communicate with the light modules and masters in other rooms, for example in the another room 105, in a similar manner.

Controlling the light modules 102 and the master 106 by a mobile visible light source 302 may also be applied to the embodiments 100 and 200.

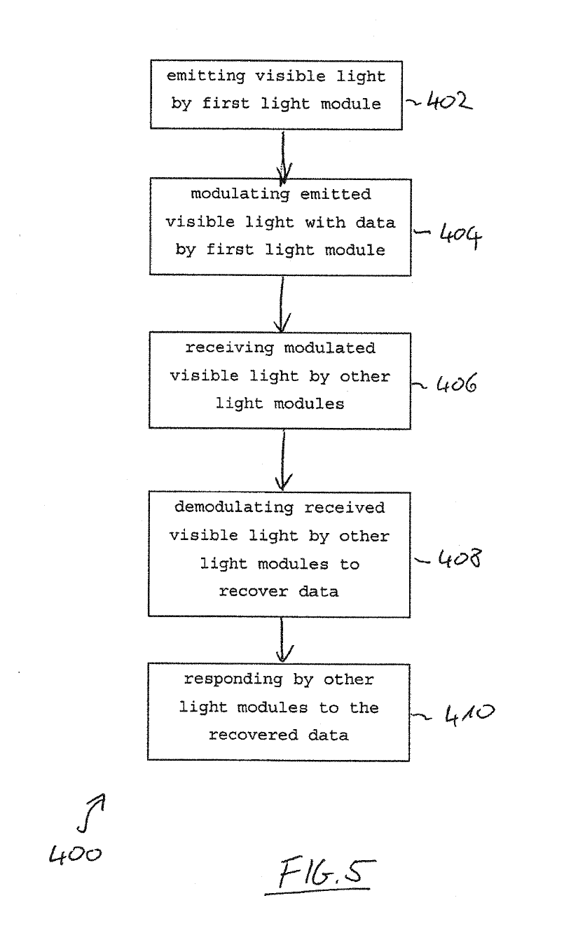

FIG. 5 shows an embodiment 400 of a method for controlling a plurality of light modules. The plurality of light modules may for example be the plurality of light modules 102 described in conjunction with embodiments 100, 200 and 300. The plurality of light modules 102 may be controlled to emit visible light, for example, for illuminating one or more rooms with a given intensity or color temperature.

In step 402, a first light module 102, 106 may emit visible light. The visible light may be suitable for illuminating one or more rooms, for example rooms 104 and 105.

In step 404, the emitted visible light may be modulated with data that is to be transferred to at least one other light module 102, 106. The modulation of the visible light maybe chosen so that it is not noticeable to the human eye.

In step 406, the modulated visible light may be received by the at least one other light module 102, 106.

In step 408, the received visible light may be demodulated by the at least one other light module 102, 106 in order to recover the data.

In step 410, the at least one other light module 102, 106 may respond to the recovered data. However, this step is optional.

In various embodiments, the at least one other light module 102, 106 may respond by emitting visible light based on the data for the demodulating received visible light.

In various embodiments, the at least one other light module 102, 106 may respond by sending data to the first light module by modulating the visible light it emits. The data may include information about at least one of the following: an identifier or address of the at least one other light module; an operating parameter of the at least one other light module; a temperature of the at least one other light module; an up-time or running time of the at least one other light module;

a power consumption of the at least one other light module; a color temperature of the emitted visible light of the at least one other light module; a brightness of light ambient to the at least one other light module; a color temperature of light ambient to the at least one other light module; and a light setting of the at least one other light module.

In various embodiments, the first light module may be configured as a master 106. The master may include a control input 122. The method may include communicating a state of the control input 122 to the at least one other light module 102.

In various embodiments, a group of light modules 102 may be formed. The light modules 102 in the group may be controlled with the same information by the master 106. In this manner, the group of light modules 102 may be easily controlled to have the same intensity or color temperature with a single command from the master 106. For example, the light modules 102 in the group may be turned on or off at the same time or may be adjusted to have the same intensity or brightness.

In various embodiments, a light module 102 that has no line-of-sight to the master 106, 107 may communicate with the master 106, 107 via at least one other light module 102 with which it has a line-of-sight, where the at least one of the other light modules 102 has a line-of-sight with the master 106, 107.

In various embodiments, the master 106 may be connected to a network 111 or another master 107.

In various embodiments, a color temperature of ambient light may be measured by one or more light modules 102.

In various embodiments, at least one of the plurality of light modules 102 may be controlled by a mobile flash source 302.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A device, comprising:
at least one light emitting element configured to emit visible light to illuminate a first area; and
at least one modulation module coupled to the at least one light emitting element and configured to modulate the emitted visible light with information to communicate the information to a second device such that the modulation is not visible to a human eye, and wherein the second device comprises at least a second light emitting element configured to illuminate a second area based on the information communicated by the at least one modulation module via modulating the emitted visible light.

2. The device of claim 1, wherein
the emitted visible light comprises a red component, a green component, and a blue component, wherein
the at least one of the modulation modules is configured to modulate the emitted visible light using less than all of the red component, the green component, and the blue component.

3. The device of claim 1, wherein
the information comprises at least one of the following:
an identifier or address of the device or the second device;
an operating parameter of the device or the second device;
a temperature of the device or the second device;
a running time of the device or the second device;
a power consumption of the device or the second device;
a color temperature of the emitted visible light of the device or the second device;
a color temperature of light ambient to the device or the second device;
a brightness of ambient light in the vicinity of the device or the second device; and
a light setting of the device or the second device.

4. The device of claim 1, wherein
the light emitting element comprises at least one light-emitting diode.

5. The device of claim 1, wherein
the device is configured as a master and the second device is configured as a slave.

6. The device of claim 5, wherein
the second device is arranged with least at one of:
a direct line-of-sight to the master;
an indirect line-of-sight to the master via at least one other second device, wherein one of the at least one other second devices is arranged with line-of-sight to the master; and
an indirect line-of-sight to the master via a reflective surface, a scattering surface or a diffusing surface.

7. The device of claim 5, wherein
the master comprises at least one interface configured to receive user input.

8. The device of claim 5, wherein
the master is connected to at least one of:
a network; and
another master, wherein the master and the other master are located in different rooms and are connected by a network.

9. The device of claim 1, wherein
the device is configured to be controlled by a mobile visible light source.

10. The device of claim 9, wherein
the mobile visible light source is a camera flash of a mobile communication unit.

11. The device of claim 1, wherein
the device and the second device are arranged on a same wall or a same ceiling.

12. A method for controlling a plurality of light modules for illuminating an area, comprising:
emitting visible light by a first light module of the plurality of light modules;
modulating the emitted visible light with data that is to be transferred to at least a second light module of the plurality of light modules, wherein the modulation of the visible light is not noticeable to the human eye;
receiving the modulated visible light by the second at least one light module;
demodulating the received visible light by the at least one other light module to recover the data.

13. The method of claim 12, further comprising:
responding, by the second at least one light module to the recovered data by emitting visible light based on the data of the demodulating received visible light.

14. The method of claim 12, further comprising:
responding, by the second at least one light module to the recovered data by sending data to the first light module by modulating emitted visible light, wherein the data comprises at least one of:
an identifier or address of the at least one other light module;
an operating parameter of the at least one other light module;
a temperature of the at least one other light module;
a running time of the at least one other light module;
a power consumption of the at least one other light module;
a color temperature of the emitted visible light of the at least one other light module;
a brightness of light ambient to the at least one other light module;
a color temperature of light ambient to the at least one other light module; and
a light setting of the at least one other light module.

15. The method of claim 12, further comprising:
configuring the first light module as a master, wherein the master comprises a user interface;
receiving user input via the user interface; and
communicating, by the first light module to the second light module, based on the received user input.

16. The method of claim 15, further comprising:
grouping two or more of the plurality of light modules together to form a group, wherein grouped light modules are controllable via a single command received from the master via the emitted visible light.

17. The method of claim 15, wherein
a light module that has no line-of-sight to the master light module communicates with the master via at least one other light module with which it has a line-of-sight where at least one of the at least one other light modules has a line-of-sight with the master.

18. The method of claim 12, wherein
modulating the emitted visible light comprises modulating the emitted visible light with a frequency greater than 1 kHz.

19. The method of claim 12, further comprising:
controlling at least one of the plurality of light modules by a mobile flash source or a display of a mobile communication device.

20. A lighting system, comprising:
a plurality of light modules, wherein each of the light modules is configured to emit visible light for illuminating an area;
wherein at least one of the plurality of light modules is configured to modulate the emitted visible light with information to communicate with at least one other of the plurality of light modules, wherein the modulation of the visible light is not noticeable to a human eye.
